(19) United States
(12) Patent Application Publication
(10) Pub. No.: US 2006/0027207 A1
(43) Pub. Date: Feb. 9, 2006

(54) Oscillating-rotary engine

(76) Inventor: Vasile Hangan, Runcu Salvei (RO)

Correspondence Address: Hangan V Vasile, Principala Nr 5, Runcu Salvei, 427256, RO

(21) Appl. No.: 10/485,025

(22) PCT Filed: Jun. 10, 2002
(86) PCT No.: PCT/RO02/00015

§ 371 Date: Jan. 14, 2004

(30) Foreign Application Priority Data
Jul. 16, 2001 (RO) A2001-00811

(51) Int. Cl. F02B 53/00; F01C 1/00

(52) U.S. Cl. 123/245; 418/36

(57) ABSTRACT

This invention refers to an oscillating-rotary engine with internal combustion in four strokes and it is made from a block-engine with a single cylinder 1, tightened by to lids 2 and 3, the frontal lid 2 has two orifices 4 and 5 for the inlet and outlet galleries and a spark-plug 6; inside the cylinder, in two bearings 7 and 8 there is an oscillating-rotor unit consisting of a special central hub 9 and two pairs of blades (A-B, C-D), which produces mechanical work under the form of an oscillating rotation; this mechanical work is changed into a continuous rotation by a special gear-group that is placed in case 12; the rotation is transmitted to a shaft-engine 13.

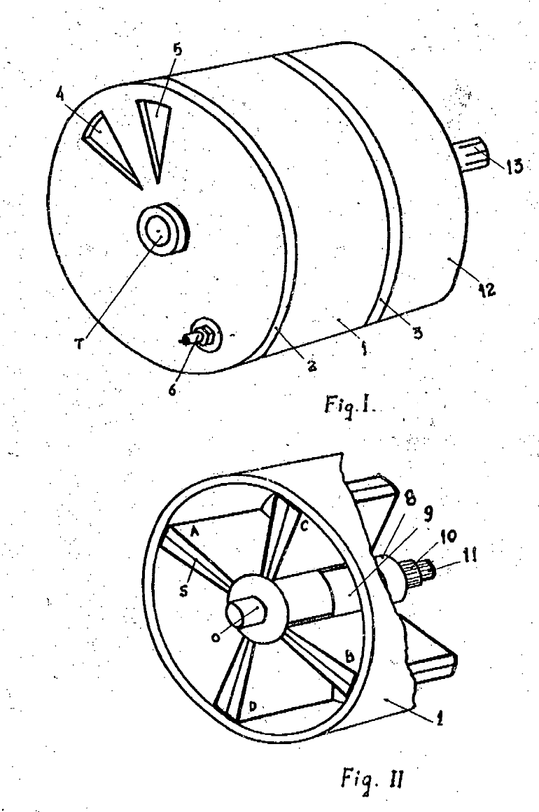

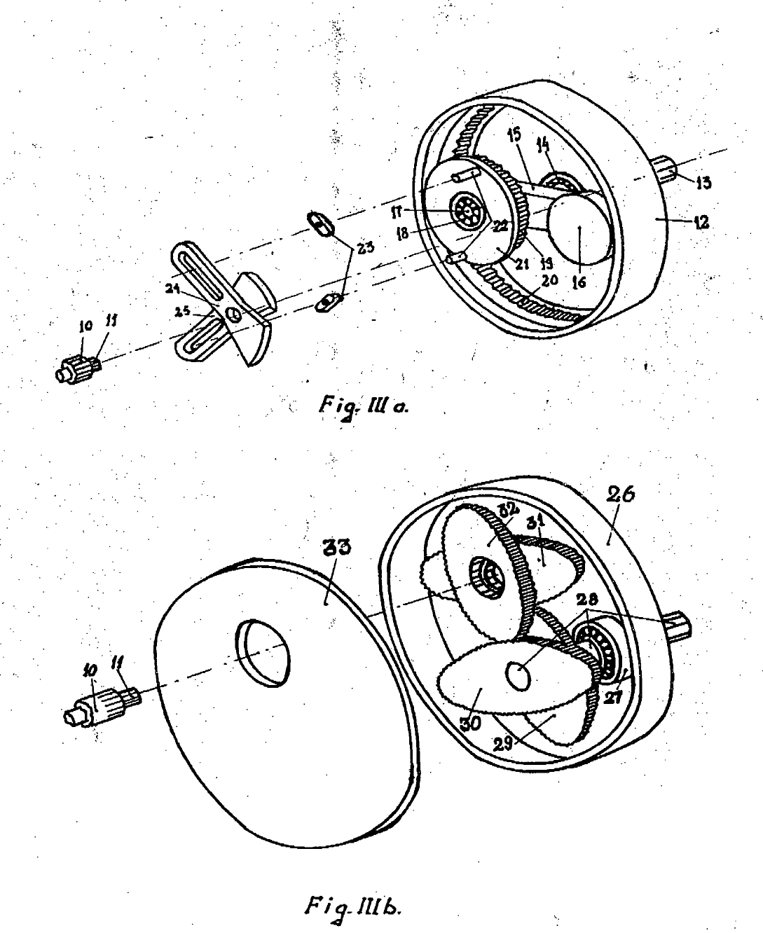

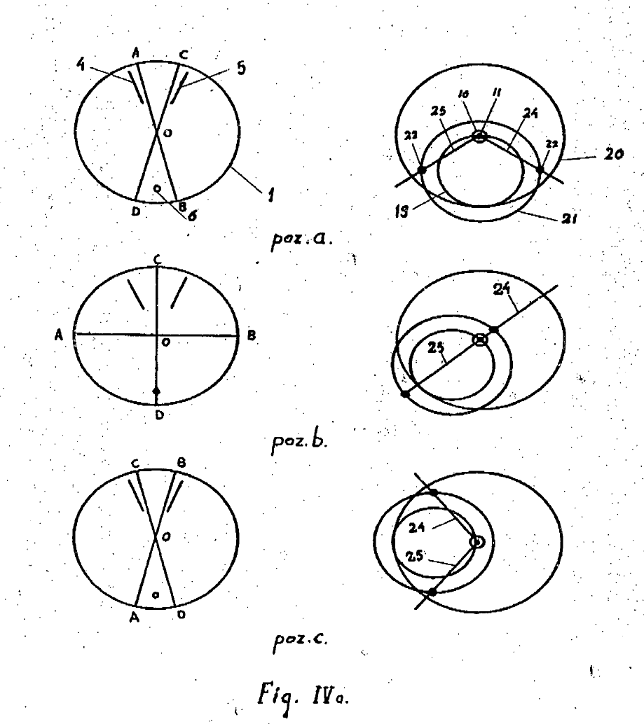

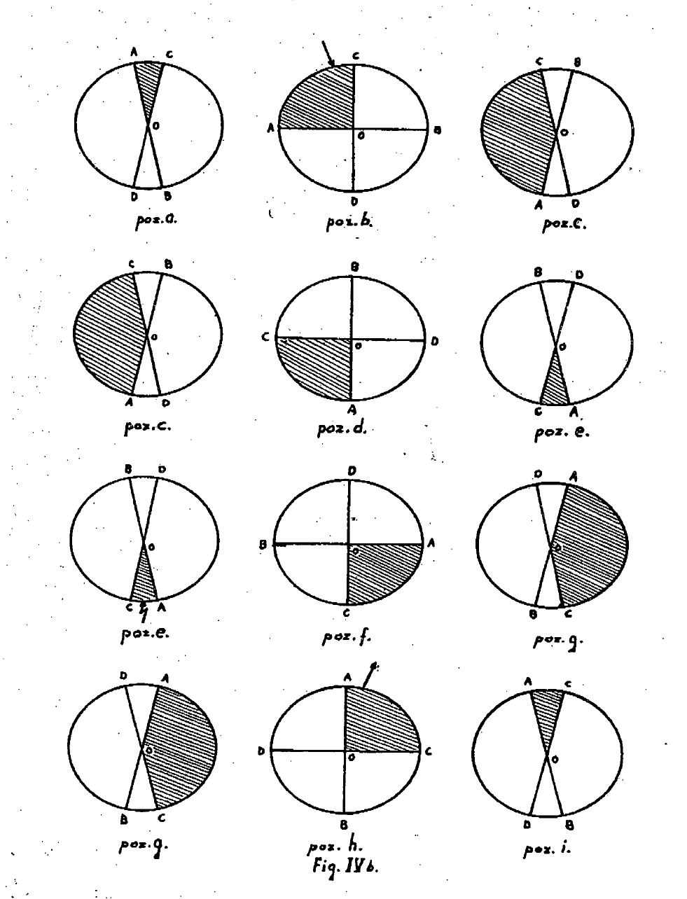

This invention refers to an oscillating-rotary engine with internal combustion in four strokes.

It is known that the most widely spread type of engine, although there were a lot of tries to replace it, is the classical internal combustion engine, made from cylinders and pistons with alternative movement, which contains a few disadvantages such as:
complicated contruction which involves cylinders, pistons, piston-rods, bend shafts, cam shafts, valves with very complex mechanism for operating and control;
large size and weight in ratio with its power;
short duration of its functioning, because of the complexity and wear made by intense frictions;
low efficiency, because of come-and-go movement made by some of its heavy parts with intense fiction;
high-level of pollution;
high level of trepidation which involves heavy fly-wheels for decreasing it;
complicated system of lubrication, ignition and cooling.

This invention refers to an oscillating-rotary engine with internal combustion in four strokes, which does not result the disadvantages mentioned above, because this engine has a compact design which consist of a block-engine with a single cylinder, equipped with only one inlet gallery, one outlet gallery, one spark-plug; within the block-engine there is an oscillating-rotor unit which is very well balanced from the point of view of the centrifugal-power which are set free. The oscillating-rotary engine is thus conceived that in the cylinder the four strokes of the internal combustion engine are carried out simultaneously developing a mechanical work under the form an oscillating rotation which by means of a special gear is turned into a continuous rotation and conveyed to a bend-shaft.

The oscillating-rotary internal combustion engine has the following advantages:
it is a compact engine, of a simple construction, easy to built, very practical because it doesen't contain piston rods, bend shafts, cam shafts or, valves with complex mechanisms for operating and control;
high power in ratio with its size and weight because of a maximum couple of forces in the rotation way;
high duration of functioning because of a small number of parts in friction;
high efficiency there are no heavy parts in the come-and-go movement with intense frictions and big inertia;
low noise level because of a high number of combustions/rotation and centrifugal balance of the gears in its rotation movement;
very simple lubrication, ignition and cooling system.

An example of the construction and functioning of the oscillating-rotary engine in four strokes, with internal combustion follows:

FIG. I—panoramic view of the engine;

FIG. II—internal view of stator and oscillating-rotor units of the engine;

FIG. III(a, b)—coupling-group ensemble in the two variants:

FIG. III.a.—the model “reversible lever”;

FIG. III.a.—the “variable driving”;

FIG. IV—functioning way:

FIG. IV.a.—the mode of interconecting “blades-arms” of engine;

FIG. IV.b.—the mode of passing through the four beams (steps) of the engine during the functioning;

The oscillating-rotary internal combustion engine consists of three units (ensembles): a stator ensemble and an oscillating-rotor ensemble which both produce two anti-phased oscillating rotations and a coupling-group ensemble which is taking over the two anti-phased oscillating rotations and turns them into a uniform rotation movement conveyed to the shaft-engine.

The stator unit has the following components: cylinder 1, which tightnes is, given by lids 2 and 3—the front lid 2 has two windows 4 and 5, the window 4 is the orifice for the inlet galery, the window 5 is the outlet gallery, a spark-plug 6, two bearings 7 and 8 in the centre of the two lids.

The oscillating-rotor unit consists of a special central hub 9 which has attached two concentric shafts 10 and 11; the exterior-side of the hub is built from two parts on which there are attached two pairs of, blades A-B and C-D. On every edge of the blades the segments S are fixed, which assure the tightness. The pair of blades A-B can rotate independently from the pair of blades C-D when the shaft 10 is rotating independently from shaft 11.

The coupling-group unit is built in two variants: The first of them is the model “reversible lever” which has two arms 24 and 25.

Every arm has a longitudinal groove and two counter-weights. Each arm is attached in those two concentric shafts 10 and 11. Inside those two grooves of the arms 24 and 25, through two “skates” 23, two bolts; 22 are sliding. They are set on the disk 21, of a rack wheel 19 which is moving in circle by rotation on the toothed crown 20. This toothed crown has a double number of teeth compared to the rack wheel 19 which is set inside the case (carcasse) 12.

The rack wheel 19 is set on a rotating arm 15 by the help of a bearing 18 which is introduced into a short shaft 17, attached on the rotating arm 15, which is set on the engine-shaft 13.

The rotating arm 15 has a counter-weight 16 for balancing.

For a better mechanical stability the engine-shaft is sustained by a group of bearings 14 which are set in the protectiv case 12.

So, if you rotate the engine-shaft in a way, it will move the rack wheel into a revolution movement in the same way. These rotation movement will make the two bolts move in two rotating and oscillating movements and because of the bolts positioning, those two movements will be anti-phased.

In this way those two bolts that are linked by the two “skates” on the two arms, will make those two arms move in two rotating 9 and oscillating anti-phased movements too, conveyed to the oscillating-rotor unit (ensemble),

Because the system is reversible if the two pairs of blades are rotated “rotary-oscillating” by the whole coupling-group unit, the engine-shaft will have a continuous rotating movement.

The whole group of parts moving in rotation, because of the inertia, acts like a fly-wheel which damps the oscillations of the engine-coupling and maintains the whole mechanism in a permanent lack of balance, making it rotate continuously in one way

The second variant of coupling-group is the model “variable driving” which works on the principle of transmission without slide of a couple of forces with the transmission ratio of periodic variable. It is built from a protective oval case 26 which is hold by a group of bearings 27, the engine shaft 28 where there are two jointly fixed rack wheels 29 and 30 having the sape of an elliptical cylinder having the correspondents radii in perpendicular position. These rack wheels have the role of a fly-wheel and are set to work by two other rack wheels 31 and 32 fixed independently in the two concentric shafts 10 and 11 of oscillating-rotor unit; the rack wheels have the same geometrical form as the rack wheels 29 and 30 fixed on the engine-shaft 28 but they are made of light materials or they are hollow and their resistance is ensured by spokes in the interior with a view to keep inertia as low as possible, the whole gear-group being attached with the stator unit through an adapting plate 33.

The oscillating-rotor unit and the stator unit, by the help of the two pairs of blades, make four separate rooms with variable volumes and communicate at pre established moments while they are rotating, with the orifices of the inlet and outlet gallery.

The oscillating-rotary engine is in such a way assembled that the two units, the oscillating-rotor unit and the coupling-group unit, will be interconnected, so that the pair of blades A-S will activate arm 24 and the pair of blades C-Dl will activate arm 25. The engine, while functioning, goes from position “a” to “i”, and the four strokes take place;
admission—when the blades start to move from position “a”, the orifice of the inlet gallery is opened by the pair of blades A-B, it makes the aspiration of the air-fuel mixture, goes to the position “b”, the AOC room increases its volume and goes to the position “c”.
compression—when the blades go from position “c”, the orifice of the inlet gallery is closed by the pair of blades C-D, goes to the “position, the AOC room decreases its volume and compresses the air-fuel mixture and goes to position “e”;
combustion—the blades go from position “e” to position “f”, when the spark-plug lights the air-fuel mixture, the AOC room increases its volume, the burnt gases make a mechanical work, go to position “g”, open the orifice of the outlet gallery with the help of the pair of blades A-B.
evacuation—the blades go from positioning” to position “h”, the AOC room decreases its volume and eliminates the burnt gases through the outlet gallery which opens and go to position “i”.

At this engine, every moment there is an active phase—combustion—which produces a mechanical work. The other phases develop simultaneously in the other rooms.

1. The oscillating-rotary internal combustion engine is characterized by the fact that for the scope to obtain a simple construction and high efficiency it is made up of a stator unit consisting of a tightened cylinder (1) closed by two lids (2, 3), of a front lid (3) with two orifices (4, 5) for the inlet and outlet gallery (4, 5) and a spark-plug (6): inside the cylinder (1), sustained by two bearings (7, 8) set in the center of the lids, there is an oscillating-rotor unit, balanced from centrifugal power point of view, made from two pairs of blades (A-B, C-D), on which edges are set segments (S) which assure the tightness, the blades are set on a central hub (9), its rotation axle is the same with the geometrical point (0) of the two lids 12, 3), from this hub there are going out two concentric shafts (10, 11) and that are thus designed that when the shaft (10) towards the other shaft (11) a pair of blades (A-B) are allowed to rotate independently towards the other pair of blades (C-D), in this way there are created four distinct rooms inside the cylinder (1), between the lids (2, 3) and the surface of the blades (A-B, C-D); during the working of the engine in the inside the rooms there is developed, through the alternative rotation and an 180° anti-phase of the blades (A-B, C-D) a shifting with a volume variation of all rooms thus, inside every room, at a shifting of 360° of the two pair of blades (A-B, C-D), which have also the role of permitting the communication of a certain room through the two windows (4, 5) with a certain inlet gallery or outlet gallery at pre established moments and by the positioning of the windows on the front lid (2) and thus the four strokes are realized (admission, compression, combustion and evacuation) of an internal combustion engine and due to the fact there are four rooms, every moment there will exist an active phase (combustion), which through the pressure caused by the burnt fuel-mixture lighted by the spark-plug (6) set on the front lid (2), will drive the pairs of blades (A-B, C-D) with a power-couple with the help of a gear-group (coupling group) built in two variants: the model “reversible lever” and the model “variable driving” from a protector case (12); the model “reversible lever” works on the principle of levers with variable positions of the points where both the active force and the resistance force act with a variable support point, which turns reversible from saving-movement levers into saving-power levers and produce a one-way rotation movement and will turn the oscillation movement of the two concentric shafts (10, 11) into a uniform rotation movement which is maintained inertial by the whole system and having also a role of a fly-weel: it is made from a shaft-engine (13) which is set in the center of the case (12) with the help of a bearings group (14) and on which there is set a rotating arm (15) which has a counter-weight (16) on one edge and on the other edge a short shaft (17) which through the agency of a bearing (18) sustains a rack wheel (19) which has a number “n” of teeth and rotates inside the case on a toothed-crown (20) which has a number of teeth “2n” set inside the case (12), on the rack-wheel (19) there is set a disk (21) having in two opposite points two bolts (22) which are driven by the help of two pieces named “skates” (23) by two arms with counter-weights (24, 25) which arms have a groove where the pieces named “skates” (23) are sliding fixed to the two concentric shafts.

2. The oscillating-rotary engine, according to claim 1, characterized by the fact that the blades (A-S, C-D), which modify the volume of the four rooms and determine the volumetric proportion, can be made in such a size and shape, that a big volumetric proportion will result and this way the engine will function by ignition compresion (Diesel).

3. The oscillating rotary engine according to claims 1 and 2, characterized by the fact that it has on the contact surface of the blades (A-B, C-D) segments for tightness, lubrication is made by oil, which is poured inside the blades and if there is a circulation of oil inside the blades and an external radiator a good cooling of the entire oscillating-rotor unit will exist.

4. The oscillating-rotary engine, as claim 3 says, is characterized by the fact that oscillating-rotor unit does not touch the cylinder or the lids of the stator; only the rectangular segments touch and are pressed by flexible bands with spring effect whose length doesn't change while functioning; segments are made from porous steel or other self-lubricants, being wide enough so that they needn't be replaced repeatedly, the engine can function a long time without modifying its characteristics or the level of the polluting gases.

5. As claim 1 says, the stator unit is made of double walls; and in the empty space between them the cooling liquid will circulate achieving the cooling of the engine.

6. According to claim 1 the lubrication system of the whole gear-group (coupling-group) is made by introducing oil to an established level in the protector case (12) and by stirring up the oil through the agency of the rack wheel (19) and the two arms (14, 25).

7. According to claim 1, the orifices of the inlet and outlet galleries (4, 5) and the spark-plug (6) are set on the front lid (2); at the high revolution engines, the orifices will be replaced by slots or more orifices placed on the length of the cylinder and the spark-plug will be replaced ‘by a row’ of spark-plugs placed at the same-distance from each other and on the whole length of the cylinder to achieve a complete burning of the air-fuel mixture, in different places assuring this way a complete burning; there will no longer be unburnt gases in the evacuated gases.

8. On the cylinder (1), for cooling the stator unit, there will be set: a few small wings with thermal radiation effect; the air-flow from: a blower will be controlled by an electronical device set on the cylinder.

9. The oscillating-rotary engine acording to claim 1, is characterized by the fact that for obtaining a simple construction, high efficiency and a long liability, the coupling-group unit model “variable driving”—which works on the principle of transmission without slide of a couple of forces having the transmission ratio of periodic variable, is built from a protective oval case (26) which sustains by the help of a bearings-group (27) the engine-shaft (28) in which exist two jointly fixed rack wheels (29 and 30) with form of elliptical cylinder having the correspondents radii in perpedincular position; these rack wheels have a role of fly-wheel and are put to work by two other rack wheels (31 and 32) fixed independently in the two concentric shafts (10 and 11) of oscillating-rotor unit; these rack wheels have the same geometrical form as the rack wheels (29 and 30) fixed an the engine-shaft (28) but are made of light materials or they are hollow and their resistance is ensured by spokes in the interior with a view to keep inertia, as low as possible, the whole gear-group being attached with the stator unit through an adapting plate (33).

10. This type of oscillating-rotary engine with internal combustion in four strokes may to be used to equip flying and nautical devices (ships, boats) transport vehicles (lorries, cars, buses, motorcycles), agricultural machines (all types of tractors and combines) and for all types of machines which work by mechanical driving, depending on the construction mode: sparkling or compresion.

11. The four stroke rotary-oscillating engine with internal combustion is, according to claim 1, characterized through the fact that—taking into account its working principle—it may be adapted constructively to fulfill the role of a compressor or a volumetric pump.
